(19) United States
(12) Patent Application Publication
(10) Pub. No.: US 2026/0297457 A1
(43) Pub. Date: Oct. 1, 2026

(54) CLEANING COMPOSITION AND CLEANING METHOD

(71) Applicant: Novozymes A/S, Bagsvaerd (DK)

(72) Inventors: Trisha DUPNOCK, Durham, NC (US); Kenneth Edmund KELLAR, Fuquay Varina, NC (US); Ki Hoon HONG, Morrisville, NC (US)

(73) Assignee: Novozymes A/S, Bagsvaerd (DK)

(21) Appl. No.: 19/478,135

(22) PCT Filed: Apr. 25, 2024
(86) PCT No.: PCT/US2024/026308

§ 371 Date: Oct. 23, 2025

Related U.S. Application Data
(60) Provisional application No. 63/498,371, filed on Apr. 26, 2023.

(51) Int. Cl. C11D 1/29; C11D 1/14; C11D 1/75; C11D 1/835; C11D 3/386

(52) U.S. Cl. CPC C11D 1/29; C11D 1/146; C11D 1/75; C11D 1/835; C11D 3/38618; C11D 3/38627; C11D 3/38636; C11D 3/38645; C11D 3/38654

(57) ABSTRACT

The present invention relates to cleaning composition having reduced aerosolization property, comprising at least one primary surfactant and at least one secondary surfactant and optionally a buffering system.

### REFERENCE TO A SEQUENCE LISTING

This application contains a Sequence Listing in computer readable form, which is incorporated herein by reference.

### FIELD OF INVENTION

This invention relates to a cleaning composition having reduced aerosolization property, which comprises at least one low-atomizing surfactant primary surfactant having 8 to 12 carbon units; and at least one secondary surfactant. The invention also relates to methods for cleaning a surface comprising foaming said composition onto the surface to be cleaned.

### BACKGROUND OF INVENTION

Most cleaners for industrial applications are high-pH (caustic) liquids. These cleaners provide risks for both the person doing the cleaning and for the environment. One improvement is applying the cleaner at room temperature versus higher temperatures such as 40-55° C. A second improvement is to reduce the volume of liquid cleaner applied, which is accomplished in two ways through using a foam. First, it would require less liquid to provide coverage of the cleaning area. Second, it would provide a visual marker so that over-spraying would be greatly reduced. However, acceptable wash performance would be difficult to achieve if the pH of the applied liquid were reduced because a high pH improves penetration and removal of dirt and organic matter such as fats, oils, and proteins. To reduce the pH and still remove the dirt and organic matter, enzymes can be added to the cleaner. Historically however, safety concerns exist around aerosolizing enzymes, resulting in allergic reaction. In addition, enzyme stability is another factor that limits the use of enzymes in industrial cleaners. There remains a need to provide a cleaning composition that can address at least one of the above problems.

### SUMMARY OF INVENTION

The present invention relates to a cleaning composition having reduced aerosolization property, comprising:
(i) at least one primary surfactant, wherein the primary surfactant has 8 to 12, e.g., 8-10 or 10-12 carbon units;
(ii) at least one secondary surfactant, wherein the secondary surfactant has 8 to 16, e.g., 8-10, 10-12 or 10-14 carbon units; and optionally
(iii) a buffering system.

The cleaning composition of the present invention is less harmful to the environment and the user as compared to the traditional high pH detergent. It is safe for foam application (reduced aerosolization level) and can be applied at room temperature and neutral pH while still providing cleaning efficacy that is similar to or better than a traditional detergent.

In addition, the foam resulting from the application of the cleaning compositions of the invention promotes better cleaning performance by generating stable foam, providing efficacious soil removal and low surface tension. However, many of these compositions cannot provide long-term enzyme stability. Other compositions, such as concentrates, can be formulated to provide long-term enzyme stability thereby enhancing the safety and convenience for the end-user.

The invention further relates to a method for cleaning a surface e.g., a hard surface, comprising: (a) foaming (e.g., spraying or brush application) the cleaning composition as described above onto said surface; and optionally (b) rinsing the surface.

### Definitions

As used herein, the singular forms “a”, “an”, and “the” are intended to include the plural forms as well, unless the context clearly indicates otherwise.

If not indicated otherwise, all references to percentages (%) in relation to the disclosed compositions relate to wt % relative to the total weight of the respective composition.

Unless defined otherwise or clearly indicated by context, all technical and scientific terms used herein have the same meaning as commonly understood by one of ordinary skill in the art to which this invention belongs.

Cleaning components: The term “cleaning components” is defined herein to mean the types of chemicals which can be used in cleaning compositions. Examples of cleaning components are alkalis, surfactants, solvents, hydrotropes, builders, co-builders, chelators or chelating agents, bleaching system or bleach components, polymers, foam boosters, suds suppressors, dispersants, dye transfer inhibitors, perfume, bactericides, fungicides, corrosion inhibitors, soil suspending agents, soil release polymers, anti-redeposition agents, enzyme inhibitors or stabilizers, enzyme activators, antioxidants, preservatives, solvents and solubilizers.

Cleaning composition: The term “cleaning composition (may also be referred as “detergent composition”) refers to compositions that find use in the removal of undesired compounds from items to be cleaned, such as a hard surface). The cleaning composition may be used to e.g., for household cleaning and industrial cleaning. The terms encompass any materials/compounds selected for the particular type of cleaning composition desired and the form of the product (e.g., liquid, gel, powder, granulate, paste, or spray compositions). In addition to containing a surfactant of the invention, the cleaning composition of the present invention may contain one or more enzymes selected from the group consisting of lipases, amylases, proteases, cellulases, mannanases, pectinases, hemicellulases, peroxidases, xylanases, phospholipases, xyloglucanases, esterases, cutinases, laccase, keratinases, reductases, oxidases, phenoloxidases, lipoxygenases, ligninases, pullulanases, malanases, β-glucanases, arabinosidases, hyaluronidase, deoxyribonucleases (DNases), RNase, hexosaminidases, peroxidases, and any mixture thereof, and/or at least one cleaning component as described above.

Hard surface: The term “hard surface” includes household surfaces e.g., showers, sinks, toilets, bathtubs, countertops, windows, mirrors, floors, chicken hatchery and the like, and industrial surfaces such as transportation vehicles, storage tanks, bioreactors, fermenters, mix vessels, pipelines, bottling line equipment and other equipment used in biotech manufacturing, e.g., pharmaceutical manufacturing, food and beverage manufacturing. The term may also include surfaces of medical or dental devices which comes into contact with a patient, where the patient may be a human or an animal. Exemplary hard surface may be a surface of a steel, a rubber, a plastic, a glass, a ceramic, melamine, wood, coated surfaces, cement countertops, kitchen countertops, endoscopes, arthoscopes scalpels, hemostats, Kocher forceps, tracheotomes, etc.

Aerosolization: Aerosolization is the process or act of converting some physical substance into the form of particles small and light enough to be carried on the air i.e., an aerosol. The term is often used in e.g., medicine to refer specifically to the production of airborne particles (e.g., tiny liquid droplets) containing infectious virus or bacteria, or in enzyme relevant applications where enzyme-containing droplets or particles may be generated when an enzyme solution (e.g., a cleaning composition) is sprayed out and may cause allergy issues. For the present invention, the aerosolization property of a cleaning composition can be measured as particle aerosolization according to the method described in Example 1 or as enzyme aerosolization according to the method described in Example 2.

Mature polypeptide: The term “mature polypeptide” means a polypeptide in its final form following translation and any post-translational modifications, such as N terminal processing, C terminal processing (e.g., removal of signal peptide), glycosylation, phosphorylation, etc.

Sequence identity: The relatedness between two amino acid sequences or between two nucleotide sequences is described by the parameter “sequence identity”.

For purposes of the present invention, the sequence identity between two amino acid sequences is determined as the output of “longest identity” using the Needleman-Wunsch algorithm (Needleman and Wunsch, 1970, J. Mol. Biol. 48:443-453) as implemented in the Needle program of the EMBOSS package (EMBOSS: The European Molecular Biology Open Software Suite, Rice et al., 2000, Trends Genet. 16:276-277), preferably version 6.6.0 or later. The parameters used are a gap open penalty of 10, a gap extension penalty of 0.5, and the EBLOSUM62 (EMBOSS version of BLOSUM62) substitution matrix. In order for the Needle program to report the longest identity, the nobrief option must be specified in the command line. The output of Needle labeled “longest identity” is calculated as follows:

(Identical Residues×100)/(Length of Alignment−Total Number of Gaps in Alignment)

Variant: The term “variant” The term “variant” means a polypeptide having same activity as the parent enzyme comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position.

### BRIEF DESCRIPTION OF THE DRAWINGS

A more complete understanding of the present invention may be derived by referring to the detailed description and claims when considered in connection with the Figures.

FIG. 1 shows the volume of different size particles generated during foam application using different detergent compositions.

### DETAILED DESCRIPTION OF THE INVENTION

The first aspect of the invention concerns a cleaning composition having reduced aerosolization property, comprising:
(i) at least one primary surfactant, wherein the primary surfactant has 8 to 12, e.g., 8-10 or 10-12 carbon units;
(ii) at least one secondary surfactant, wherein the secondary surfactant has 8 to 16, e.g., 8-10, 10-12 or 10-14 carbon units; and optionally
(iii) a buffering system.

### Composition Components

The non-limiting list of composition components illustrated hereinafter are suitable for use in the compositions and methods of the invention and may be desirably incorporated in certain embodiments of the invention, e.g. to assist or enhance cleaning performance, for treatment of e.g., a hard surface to be cleaned, or to modify the aesthetics of the composition as is the case with other ingredients such as perfumes, colorants, dyes or the like. The precise nature of these components, and levels of incorporation thereof, will depend on the physical form of the composition and the nature of the cleaning operation for which it is to be used. Although components mentioned below are categorized by general header according to a particular functionality, this is not to be construed as a limitation, as a component may comprise additional functionalities as will be appreciated by the skilled artisan.

Suitable component materials include, but are not limited to, surfactants, builders, chelating agents, dispersants, enzymes, and enzyme stabilizers, catalytic materials, bleach activators, hydrogen peroxide, sources of hydrogen peroxide, preformed peracids, polymeric dispersing agents, clay soil removal, dyes, hydrotropes, processing aids, preservatives (such as 2-Phenoxyethanol and isothiazolionones (e.g., Benzisothiazolinone (BIT), Methylisothizolinone (MIT), Chloromethylisothiazolinone (CMIT)) and solvents. In addition to the disclosure below, suitable examples of such other components and levels of use are found in U.S. Pat. Nos. 5,576,282, 6,306,812, and 6,326,348 hereby incorporated by reference.

Exemplified enzyme stabilizers may include glycerol, sorbitol, sucrose, glucose, NaCl, KCl, sodium formate, citric acid, sodium citrate tribasic dihydrate, hexanediol, heptandiol, PEG 300, and PEG 600, and the mixture thereof. The enzyme stabilizer may be present in the composition of the present invention at a level of 0.5-25 wt %, preferably 1-20 wt %, more preferably at a level of 3-15 wt %, e.g., 5-15 wt %, 4-12 wt %.

### Surfactants

A detergent or cleaning composition of the present invention comprises at least one primary surfactant and at least one secondary surfactant to achieve foam stability. The primary surfactant is to generate sufficient foam with whatever means is used to generate that foam. The secondary surfactant in the present invention is expected to lower the surface tension to a desirable level and to increase foam stability and enhance foam generation.

The primary surfactant may be a detergent surfactant that has 8 to 12 carbon units. Any value higher than 12 carbon units may lead to poor foam generation. Any value smaller than 10 carbon units may lead to poor foam generation and the foam that is generated may have poor stability.

The primary surfactant may be selected from the group consisting of sodium, potassium, or ammonium salts and mixture thereof.

The primary surfactant may comprise one or more anionic surfactants, e.g., linear alkylbenzenesulfonic acid (LAS), alcohol ethersulfate (AEOS) and/or alkyl sulfate (AS), in particular sodium lauryl sulfate (SLS), sodium laureth sulfate, sodium lauryl ether sulfate, sodium dodecyl sulfate, ammonium decyl ether sulfate, sodium decyl sulfate and ammonium alkyl ether sulfate.

The primary surfactants may be anionic surfactants such as sulphate and sulphonate detersive surfactants.

Suitable sulphonate surfactants include alkyl benzene sulphonate, in one aspect, C₁₀₋₁₃ alkyl benzene sulphonate. Suitable alkyl benzene sulphonate (LAS) may be obtained, by sulphonating commercially available linear alkyl benzene (LAB); suitable LAB includes low 2-phenyl LAB, such as Isochem® or Petrelab®, other suitable LAB include high 2-phenyl LAB, such as HybleneR. A suitable anionic detersive surfactant is alkyl benzene sulphonate that is obtained by DETAL catalyzed process, although other synthesis routes, such as HF, may also be suitable. In one aspect a magnesium salt of LAS is used.

Suitable sulphate surfactant is alkyl alkoxylated sulphate, in one aspect, alkyl ethoxylated sulphate, in one aspect, a C₈₋₁₂ alkyl alkoxylated sulphate, in another aspect, a C₈₋₁₂ alkyl ethoxylated sulphate.

The alkyl sulphate, alkyl alkoxylated sulphate and alkyl benzene sulphonates may be linear or branched, substituted or un-substituted.

Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS) or sodium lauryl sulfate (SLS), fatty alcohol sulfates (FAS), primary alcohol sulfates (PAS), alcohol ethersulfates (AES or AEOS or FES, also known as alcohol ethoxysulfates or fatty alcohol ether sulfates), sodium laureth sulfate (SLES), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), ammonium alkyl ether sulfate, fatty acid derivatives of amino acids, diesters and monoesters of sulfo-succinic acid or soap, and combinations thereof.

The primary surfactant is present at a level of from 0.2 to 60 wt %, from 0.5 to 40 wt %, from 0.8 to 30 wt %, from 1 to 50 wt %, from 1 to 40 wt %, from 1 to 30 wt %, from 1 to 20 wt %, from 3 to 10 wt %, from 3 to 5 wt %, from 5 to 40 wt %, from 5 to 30 wt %, from 5 to 15 wt %, from 2 to 20 wt %, from 3 to 6 wt %, from 8 to 12 wt %, from 10 to 12 wt %, from 20 to 25 wt % or from 25-60%.

The secondary surfactant may be a detergent surfactant having have 8 to 16, e.g., 8-10, 10-12 or 10-14 carbon units. Preferably, secondary surfactant is selected from the group of consisting of amine oxides, betaines, primary fatty alcohols, monoethanolamides, diethanolamides, and mixture thereof.

The secondary surfactant is desirable to have about same carbon units as the primary surfactant to achieve better foam properties (easily be generated, stability, adhesion, etc.).

Ideally, the secondary surfactants should be low-volatilizing. In the present invention, the term “volatilize” or “volatilization” can be used interchangeably with “atomize” or “atomization”, respectively.

The volatility of the surfactant is evaluated indirectly by the particle aerosolization according to Example 2.

The secondary surfactant is selected from amine oxide, decylamine oxide, lauramine oxide and mixture thereof. In one embodiment, the secondary surfactant may further comprise primary fatty alcohols such as 1-dodecaol, 1-decanol and/or linear alcohol (c12-13) ethoxylate e.g., linear alcohol (c12-13) ethoxylate poe-3.

The secondary surfactant is present at a level of from 0.01 to 10 wt %, from 0.02 to 8 wt %, from 0.05 to 6 wt %, from 0.1 to 5 wt %, from 0.5 to 4 wt %, from 1 to 3 wt %, from 1.5 to 8 wt %, or from 2 to 6 wt %.

The amount of secondary surfactant is present less than the primary surfactant in the composition. The ratio of the secondary surfactant to the primary surfactant by weight may be in the range of 0.001-1, e.g., in the range of 0.005-0.9, in the range of 0.01-0.8, in the range of 0.1-0.6, in the range of 0.08-0.5, or in the range of 0.2-0.4.

The surface tension of the cleaning composition of the invention is ideally 35 mN/m or lower, e.g., 30 mN/m or lower, 28 mN/m or lower, or even better 25 mN/m or lower, or 20 mN/m or lower. Lower surface tensions provide for better chemical cleaning effect and better enzyme penetration (so that the enzymes can provide a good cleaning function). Surface tension can be measured by methods known in art. It can be adjusted by e.g., adjusting the amount/type of the primary surfactant and the secondary surfactant of the invention.

The cleaning composition may further comprise a buffering system to stabilize enzymes and/or maximize enzyme performance. A buffering system is a type of solution that is able to resist changes in its pH when small amounts of an acidic or basic substance is added to it. Buffering system typically contains a conjugate base and acid system.

In one embodiment, the buffering system comprises TRIS-HCl/TRIS-base or citric acid/citrate or sodium carbonate/sodium bicarbonate, potassium carbonate/potassium bicarbonate.

The buffering system is comprised in the cleaning composition at a level of 0.02 to 10 wt %, e.g., from 0.05 to 8 wt %, from 0.1 to 6 wt %, from 0.5 to 5 wt %, from 1 to 4 wt %, from 2 to 6 wt % or from 3 to 5 wt %.

The reduced aerosolization benefit of the composition may be evaluated as particle aerosolization by the 20-minute foam test according to Example 1. Accordingly, in one embodiment, when the composition is evaluated by the 20-minute foam test according to Example 1, the volume of particles sized at 0.3 μm is no more than 15×10⁶ m³, e.g., below 10×10⁶ m³, 8×10⁶ m³, 6×10⁶ m³, 5×10⁶ m³, or 2×10⁶ m³. In another embodiment, when the composition is evaluated by the 20-minute foam test according to Example 1, the volume of particles sized at 0.5 μm is no more than 15×10⁶ m³, e.g., below 10×10⁶ m³, 8×10⁶ m³, 6×10⁶ m³, 5×10⁶ m³, or 2×10⁶ m³. In a further embodiment, when the composition is evaluated by the 20-minute foam test according to Example 1, the volume of particles sized at 1 μm is no more than 15×10⁶ m³, e.g., below 10×10⁶ m³, 8×10⁶ m³, 6×10⁶ m³, 5×10⁶ m³, or 2×10⁶ m³. In yet another embodiment, when the composition is evaluated by the 20-minute foam test according to Example 1, the volume of particles sized at 2 μm is no more than 15×10⁶ m³, e.g., below 10×10⁶ m³, 8×10⁶ m³, 6×10⁶ m³, 5×10⁶ m³, or 2×10⁶ m³.

The reduced aerosolization benefit of the composition may be evaluated as enzyme aerosolization concentration according to the method of Example 2. Preferably, the enzyme aerosolization concentration of the cleaning composition is no more than 100 ppb, e.g., no more than 80 ppb, no more than 60 ppb, no more than 50 ppb, no more than 30 ppb, no more than 20 ppb, no more than 15 ppb or no more than 10 ppb.

The composition is preferred to be formulated suitable for a foam type cleaner.

The present invention can be formulated to have a lower pH than a convention cleaning composition, e.g., below 11, preferably in the range of 6-9.5, in the range of 6.5-9, in the range of 6.8-8.5, or in the range of 7-8, more preferably have a neutral pH of 6.5-7.5, such as pH 7.0, 7.1 or 7.

The present invention may be formulated as a ready-to-use detergent or as a concentrate (e.g., 2×, 5×, 10× or 15× concentrated) detergent that can be diluted onsite before application. Enzyme(s) may be added when formulating the concentrate or added to the diluted version onsite.

According to the invention, the foam produced by the cleaning composition of the present invention has the following characteristics. First, to form readily without requiring high pressures to generate the foam. Second, to adhere to all types of surfaces, especially vertical and horizontal surfaces. Third, to be stable to allow sufficient time for the enzymes to provide a cleaning benefit. Fourth, to allow enzymes to penetrate the dirt and soils that are on the surfaces so that the enzymes can provide a cleaning benefit. Fifth, to greatly reduce the aerosolization of enzymes to minimize exposure related to allergic sensitization.

In one embodiment, in addition to the enzyme(s) of the invention, the detergent composition further comprises an enzyme selected from the group of protease, cellulase, mannanase, amylases, lipases, hemicellulases, peroxidases, xylanases, phospholipases, esterases, cutinases, keratinases, reductases, oxidases, phenoloxidases, lipoxygenases, ligninases, pullulanases, β-glucanases, arabinosidases, hyaluronidase, laccase, deoxyribonucleases (DNases), hexosaminidases and, or any mixture thereof. A typical combination is an enzyme cocktail that may comprise e.g., a protease and lipase in conjunction with an alpha-amylase, phospholipases, cutinases, pectinases, mannanases, pectate lyases, phosphodiesterases (PDEs), deoxyribonucleases (DNases), xanthanase, dispersin, or mixtures thereof.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts. Generally, when present in a cleaning composition, the enzyme(s) may be present at levels of at least 0.001 mg of enzyme protein, at least 0.006 mg of enzyme protein, at least 0.008 mg of enzyme protein, at least 0.01 mg of enzyme protein, at least 0.1 mg of enzyme protein, at least 0.5 mg of enzyme protein, at least 1 mg of enzyme protein, at least 1.5 mg of enzyme protein, at least 2 mg of enzyme protein, at least 5 mg of enzyme protein, at least 10 mg of enzyme protein, or at least 15 mg of enzyme protein.

Cellulases: In one aspect, suitable cellulases include mono-component and mixtures of enzymes of bacterial or fungal origin. Chemically modified or protein engineered mutants are also contemplated. The cellulase may for example be a mono-component or a mixture of mono-component endo-1,4-beta-glucanase also referred to as endoglucanase.

Suitable cellulases include those from the genera Bacillus, Pseudomonas, Humicola, Myceliophthora, Fusarium, Thielavia, Trichoderma, and Acremonium. Exemplary cellulases include a fungal cellulase from Humicola insolens (U.S. Pat. No. 4,435,307) or from Trichoderma, e.g., T. reesei or T. viride. Other suitable cellulases are from Thielavia e.g., Thielavia terrestris as described in WO 96/29397 or the fungal cellulases produced from Myceliophthora thermophila and Fusarium oxysporum disclosed in U.S. Pat. Nos. 5,648,263, 5,691,178, 5,776,757, WO 89/09259 and WO 91/17244. Also relevant are cellulases from Bacillus as described in WO 02/099091 and JP 2000210081. Suitable cellulases are alkaline or neutral cellulases having care benefits. Examples of cellulases are described in EP 0 495 257, EP 0 531 372, WO 96/11262, WO 96/29397, WO 98/08940. Other examples are cellulase variants such as those described in WO 94/07998, EP 0 531 315, U.S. Pat. Nos. 5,457,046, 5,686,593, 5,763,254, WO 95/24471, WO 98/12307.

In one embodiment, the enzyme suitable for replacing a whiteness-maintaining agent is an enzyme having cellulase activity. Suitable cellulase may be selected from glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45), preferably family GH45 cellulases.

Other cellulases are endo-beta-1,4-glucanase enzyme having a sequence of at least 97% identity to the amino acid sequence of position 1 to position 773 of SEQ ID NO:2 of WO 2002/099091 or a family 44 xyloglucanase, which a xyloglucanase enzyme having a sequence of at least 60% identity to positions 40-559 of SEQ ID NO: 2 of WO 2001/062903.

Commercially available cellulases include Celluzyme, Carezyme, Carezyme Elite, Carezyme Premium, Luminous, Celluclean, Celluclean Classic, Cellusoft, Whitezyme, Celluclean 4500T and Celluclean 5000L (all registered trademarks of Novozymes A/S), Clazinase and Puradax HA (registered trademarks of Genencor International Inc.), KAC-500 (B) (registered trademark of Kao Corporation), and Revitalenz 2000 (registered trademarks of Danisco/Dupont), and Biotouch FLX1, Biotouch FCL75, Biotouch DCL and Biotouch FCC45 (registered trademarks of AB Enzymes), and Lavergy C Bright from BASF.

Proteases: In one aspect, protease suitable for the present invention may be of any origin, but are preferably of bacterial or fungal origin, optionally in the form of protein engineered or chemically modified mutants. The protease may be an alkaline protease, such as a serine protease or a metalloprotease. A serine protease may for example be of the S1 family, such as trypsin, or the S8 family such as a subtilisin. A metalloprotease may for example be a thermolysin, e.g., from the M4 family, or another metalloprotease such as those from the M5, M7 or M8 families.

The term “subtilases” refers to a sub-group of serine proteases according to Siezen et al., Protein Eng. 4 (1991) 719-737 and Siezen et al., Protein Sci. 6 (1997) 501-523. Serine proteases are a subgroup of proteases characterized by having a serine in the active site, which forms a covalent adduct with the substrate. The subtilases may be divided into six subdivisions, the Subtilisin family, the Thermitase family, the Proteinase K family, the Lantibiotic peptidase family, the Kexin family and the Pyrolysin family.

Although proteases suitable for detergent use may be obtained from a variety of organisms, including fungi such as Aspergillus, detergent proteases have generally been obtained from bacteria and in particular from Bacillus and related genera (cf. Patel and Gupta, supra). Examples of Bacillus species from which subtilases have been derived include Bacillus lentus, Bacillus alcalophilus, Bacillus subtilis, Bacillus amyloliquefaciens, Bacillus licheniformis, Bacillus pumilus and Bacillus gibsonii. Particular subtilisins include subtilisin lentus, subtilisin Novo, subtilisin Carlsberg, subtilisin BPN′, subtilisin 309, subtilisin 147 and subtilisin 168 and e.g., protease PD138 (described in WO 93/18140). Other useful proteases are e.g., those described in WO 01/16285 and WO 02/16547.

Examples of trypsin-like proteases include the Fusarium protease described in WO 94/25583 and WO 2005/040372, and the chymotrypsin proteases derived from Cellumonas described in WO 2005/052161 and WO 2005/052146.

Examples of metalloproteases include the neutral metalloproteases described in WO 2007/044993 such as those derived from Bacillus amyloliquefaciens, as well as e.g., the metalloproteases described in WO 2015/158723 and WO 2016/075078.

Examples of useful proteases are the protease variants described in WO 89/06279 WO 92/19729, WO 96/34946, WO 98/20115, WO 98/20116, WO 99/11768, WO 01/44452, WO 03/006602, WO 2004/003186, WO 2004/041979, WO 2007/006305, WO 2011/036263, WO 2014/207227, WO 2016/087617 and WO 2016/174234. Preferred protease variants may, for example, comprise one or more of the mutations selected from the group consisting of: S3T, V4I, S9R, S9E, A15T, S24G, S24R, K27R, N42R, S55P, G59E, G59D, N60D, N60E, V66A, N74D, S85R, A96S, S97G, S97D, S97A, S97SD, S99E, S99D, S99G, S99M, S99N, S99R, S99H, S101A, V102I, V102Y, V102N, S104A, G116V, G116R, H118D, H118N, A120S, S126L, P127Q, S128A, S154D, A156E, G157D, G157P, S158E, Y161A, R164S, Q176E, N179E, S182E, Q185N, A188P, G189E, V193M, N198D, V199I, Q200L, Y203W, S206G, L211Q, L211D, N212D, N212S, M216S, A226V, K229L, Q230H, Q239R, N246K, S253D, N255W, N255D, N255E, L256E, L256D T268A and R269H, wherein position numbers correspond to positions of the Bacillus lentus protease shown in SEQ ID NO: 1 of WO 2016/001449. Protease variants having one or more of these mutations are preferably variants of the Bacillus lentus protease (Savinase®, also known as subtilisin 309) shown in SEQ ID NO: 1 of WO 2016/001449 or of the Bacillus amyloliquefaciens protease (BPN′) shown in SEQ ID NO: 2 of WO 2016/001449. Such protease variants preferably have at least 80% sequence identity to SEQ ID NO: 1 or to SEQ ID NO: 2 of WO 2016/001449.

Another protease of interest is the alkaline protease from Bacillus lentus DSM 5483, as described for example in WO 91/02792, and variants thereof which are described for example in WO 92/21760, WO 95/23221, EP 1921147, EP 1921148 and WO 2016/096711.

The protease may alternatively be a variant of the TY145 protease having SEQ ID NO: 1 of WO 2004/067737, for example a variant comprising a substitution at one or more positions corresponding to positions 27, 109, 111, 171, 173, 174, 175, 180, 182, 184, 198, 199 and 297 of SEQ ID NO: 1 of WO 2004/067737, wherein said protease variant has a sequence identity of at least 75% but less than 100% to SEQ ID NO: 1 of WO 2004/067737.

In some embodiments of the present invention, the protease is a polypeptide having protease activity and has at least 60%, such as at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the polypeptide of SEQ ID NO: 1 or 2.

In one embodiment, the protease of the invention is a variant of the polypeptide of SEQ ID NO: 2, comprising one or more substitutions selected from the group consisting of: S3T, V4I, S9E, S9R, A15T, V68A, N76D, S99D, S99G, S99A, S99SE, S101E, S101N, S101R, S103A, V104I, G160S, Y167A, R170S, A194P, V199M, V205I, Q206L, Y209W, L217D, L217Q, N218D, M222S, Q245R, N261W and L262E, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, at least 99%, but less than 100% sequence identity to SEQ ID NO: 2.

In one embodiment, the protease of the invention is a variant of the polypeptide of SEQ ID NO: 2, comprising one or more substitutions selected from the group consisting of: S3T, V4I, S9E, S9R, A15T, T22A, N43R, V68A, N76D, S87N, S99D, S99G, S99A, S99SE, S101E, S101N, S101R, S103A, V104I, G118M, S128Q, G160S, Y167A, R170S, N184E, A194P, V199M, V205I, Q206L, Y209W, L217D, L217Q, N218D, M222S, Q245R, S259D, N261W and L262E, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, at least 99%, but less than 100% sequence identity to SEQ ID NO: 2.

In one embodiment, the protease of the invention is a variant of the polypeptide of SEQ ID NO: 2, comprising the substitution S87N, wherein the variant has protease activity and wherein the position corresponds to the position of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2.

In one embodiment, the protease of the invention is a variant of the polypeptide of SEQ ID NO: 2, comprising the substitutions Y167A+R170S+A194P, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2.

In one embodiment, the protease of the invention is a variant of the polypeptide of SEQ ID NO: 2, comprising the substitutions S9E+N43R+N76D+V205I+Q206L+Y209W+S259D+N261W+L262E, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2.

In one embodiment, the protease of the invention is a variant of the polypeptide of SEQ ID NO: 2, comprising the substitutions S3T+N43R+N76D+S87N+G118M+S128Q+N184E+V205I+Q206L+Y209W+S259D+N261W+L262E, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2.

In one embodiment, the protease of the invention is a variant of the polypeptide of SEQ ID NO: 2, comprising the substitutions T22A+N43R+S87N+V205L+Q206L+Y209W+S259D+N261W+L262E, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2.

In one embodiment, the protease of the invention is a variant comprising a substitution at one or more positions corresponding to positions 171, 173, 175, 179 or 180 of SEQ ID NO: 1 of WO2004/067737, wherein the variant has protease activity and has a sequence identity of at least 80%, at least 85%, at least 90%, at least 91%, at least 92%, at least 93%, at least 94%, at least 95%, at least 96%, at least 97%, at least 98%, or at least 99%, but less than 100% to SEQ ID NO: 1 of WO2004/067737.

In one embodiment, the protease of the invention is a variant comprising one or more substitutions compared to a parent protease, selected from the group consisting of X3V, X9 [E,R], X22 [R,A], X43R, X61 [E,D], X62 [E,D], X76 [D], X87N, X101 [E,G,D,N,M], X103A, X104I, X118 [V,R], X120V, X128 [A, L,S], X129Q, X130A, X160D, X185 [E,D], 188 [E,D], X191N, X194P, X205I, X206L, X209W, X216V, X217 [Q,D,E], X218 [D,E,S], X232V, X245R, X248D, X256 [E, D], X259 [E,D], X261 [E,D,W] and X262 [E,D], wherein position numbers correspond to the positions of BPN′ (SEQ ID NO: 1), wherein “X” represents any amino acid residue present in the specified position in the parent protease, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 1 or SEQ ID NO: 2.

In one embodiment, the protease of the invention is a variant comprising any of the following substitution sets compared to a parent protease, wherein the parent protease has the amino acid sequence of SEQ ID NO: 1 or SEQ ID NO: 2 or has at least 80% sequence identity to SEQ ID NO: 1 or SEQ ID NO: 2, wherein position numbers correspond to the positions of BPN′ (SEQ ID NO: 1), wherein “X” represents any amino acid residue present in the specified position in the parent protease, and wherein the substitution set is selected from the group consisting of:

$$i . X 9 R + X 15 T + X 68 A + X 218 D + X 245 R ,$$

$$ii . X 9 R + X 15 T + X 68 A + X 245 R ,$$

$$iii . X 61 E + X 194 P + X 205 I + X 261 D ,$$

$$iv . X 61 D + X 205 I + X 245 R ,$$

$$v . X 61 E + X 194 P + X 205 I + X 261 D ,$$

$$vi . X 87 N + X 118 V + X 128 L + X 129 Q + X 130 A ,$$

$$vii . X 87 N + X 101 M + X 118 V + X 128 L + X 129 Q + X 130 A ,$$

$$viii . X76 D + X 87 R + X 118 R + X 128 L + X 129 Q + X 130 A ,$$

$$ix . X 22 A + X 62 D + X 101 G + X 188 D + X 232 V + X 245 R ,$$

$$x . X 103 A + X 104 I ,$$

$$xi . X 22 R + X 101 G + X 232 V + X 245 R ,$$

$$xii . X 103 A + X 104 I + X 156 D ,$$

$$xiii . X 103 A + X 104 I + X 261 E ,$$

$$xiv . X 62 D + X 245 R ,$$

$$xv . X 101 N + X 128 A + X 217 Q ,$$

$$xvi . X 101 E + X 217 Q ,$$

$$xvii . X 101 E + X 217 D ,$$

$$xviii . X 9 E + X 43 R + X 262 E ,$$

$$xix . X 76 D + X 43 R + X 209 W ,$$

$$xx . X 205 I + X 206 L + X 209 W ,$$

$$xxi . X 185 E + X 188 E + X 205 I ,$$

$$xxii . X 256 D + X 261 W + X 262 E ,$$

$$xxiii . X 191 N + X 209 W ,$$

$$xxiv . X 261 E + X 262 E ,$$

$$xxv . X 261 E + X 262 D , and$$

$$xxvi . X 167 A + X 170 S + X 1 \; 94 P ,$$

wherein the protease variant has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 1 or 2.

Suitable commercially available protease enzymes may include those sold under the trade names Alcalase®, Duralase™, Durazym™, Relase®, Relase® Ultra, Savinase®, Savinase® Ultra, Primase™, Polarzyme®, Kannase®, Liquanase®, Liquanase® Ultra, Ovozyme®, Coronase®, Coronase® Ultra, Blaze®, Blaze® Pro, Blaze Evity® 100T, Blaze Evity® 125T, Blaze Evity® 150T, Blaze Evity® 200T, Neutrase®, Everlase®, Esperase®, Progress® Uno, Progress® In and Progress® Excel (Novozymes A/S), those sold under the tradename Maxatase™, Maxacal™, Maxapem®, Purafect® Ox, Purafect® OxP, Puramax®, FN2™, FN3™, FN4ex™, Excellase®, Excellenz™ P1000, Excellenz™ P1250, Eraser™, Preferenz® P100, Preferenz® P300, Purafect Prime, Preferenz P110™, Effectenz P1000™ Purafect®, Effectenz P1050™, Purafect® Ox, Effectenz™ P2000, Purafast™, Properase®, Opticlean™ and Optimase® (Danisco/DuPont), BLAP (sequence shown in FIG. 29 of U.S. Pat. No. 5,352,604) and variants hereof (Henkel AG), Puzhi 1.0L from Bestzyme and KAP (Bacillus alkalophilus subtilisin) from Kao.

Amylases: In one aspect, suitable amylases may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, 1201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:

$$M 197 T ;$$

$$H 156 Y + A 181 T + N 190 F + A 209 V + Q 264 S ; or$$

$$G 48 A + T 49 I + G 107 A + H 156 Y + A 181 T + N 190 F + I 201 F + A 209 V + Q 264 S .$$

Further amylases which are suitable are amylases having SEQ ID NO: 6 in WO 99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, 1206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO 96/023873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476, using SEQ ID 2 of WO 96/023873 for numbering. More preferred variants are those having a deletion in two positions selected from 181, 182, 183 and 184, such as 181 and 182, 182 and 183, or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO 08/153815, SEQ ID NO: 10 in WO 01/66712 or variants thereof having 90% sequence identity to SEQ ID NO: 2 of WO 08/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 09/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:

$$N 128 C + K 178 L + T 182 G + Y 305 R + G 4 \; 75 K ;$$

$$N 128 C + K 178 L + T 182 G + F 202 Y + Y 305 R + D 319 T + G 4 \; 75 K ;$$

$$S 125 A + N 128 C + K 178 L + T 182 G + Y 305 R + G 4 \; 75 K ; or$$

$$S 125 A + N 128 C + T 131 I + T 165 I + K 178 L + T 182 G + Y 305 R + G 475 K$$

wherein the variants are C-terminally truncated and optionally further comprises a substitution at position 243 and/or a deletion at position 180 and/or position 181.

Further suitable amylases are amylases having SEQ ID NO: 1 of WO13184577 or variants having 90% sequence identity to SEQ ID NO: 1 thereof. Preferred variants of SEQ ID NO: 1 are those having a substitution, a deletion or an insertion in one of more of the following positions: K176, R178, G179, T180, G181, E187, N192, M199, I203, S241, R458, T459, D460, G476 and G477. More preferred variants of SEQ ID NO: 1 are those having the substitution in one of more of the following positions: K176L, E187P, N192FYH, M199L, I203YF, S241QADN, R458N, T459S, D460T, G476K and G477K and/or deletion in position R178 and/or S179 or of T180 and/or G181. Most preferred amylase variants of SEQ ID NO: 1 are those having the substitutions:

$$E 187 P + I 203 Y + G 476 K$$

$$E 187 P + I 203 Y + R 458 N + T 459 S + D 460 T + G 476 K$$

wherein the variants optionally further comprise a substitution at position 241 and/or a deletion at position 178 and/or position 179.

Further suitable amylases are amylases having SEQ ID NO: 1 of WO10104675 or variants having 90% sequence identity to SEQ ID NO: 1 thereof. Preferred variants of SEQ ID NO: 1 are those having a substitution, a deletion or an insertion in one of more of the following positions: N21, D97, V128 K177, R179, S180, I181, G182, M200, L204, E242, G477 and G478. More preferred variants of SEQ ID NO: 1 are those having the substitution in one of more of the following positions: N21D, D97N, V1281 K177L, M200L, L204YF, E242QA, G477K and G478K and/or deletion in position R179 and/or S180 or of I181 and/or G182. Most preferred amylase variants of SEQ ID NO: 1 are those having the substitutions:

$$N 21 D + D 97 N + V 128 I$$

wherein the variants optionally further comprise a substitution at position 200 and/or a deletion at position 180 and/or position 181.

Other suitable amylases are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO2011/098531, WO2013/001078 and WO2013/001087.

Commercially available amylases are Duramyl™, Termamyl™, Fungamyl™, Stainzyme™, Stainzyme Plus™, Natalase™, Liquozyme X and BAN™ (from Novozymes A/S), and Rapidase™, Purastar™/Effectenz™, Powerase, Preferenz S1000, Preferenz S100 and Preferenz S110 (from Genencor International Inc./DuPont).

Mannanases: In one aspect, suitable mannanases include those of bacterial or fungal origin. Chemically or genetically modified mutants are included. The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 1999/064619. A commercially available mannanase is Mannaway (Novozymes A/S) and Purabrite® (Danisco/DuPont).

Pectate lyases, DNases and/or PDEs: Other preferred enzymes that additionally may be comprised in the composition of the invention include pectate lyases, e.g., one sold under the tradenames Pectawash®, Pectaway®, or Xpect®. Finally, the composition may also comprise a deoxyribonuclease (DNase) and/or a phosphodiesterase (PDE).

In one embodiment, the enzyme may be comprised in the cleaning composition is a protease.

In one embodiment, the enzyme may be comprised in the cleaning composition is a protease, a lipase, a carbohydrase (e.g., an amylase) and/or combination thereof.

In one embodiment, the enzyme may be comprised in the cleaning composition is a mixture of a protease, a DNase and a hexosaminidases (e.g., a dispersin) s.

In one embodiment, the enzyme may be comprised in the cleaning composition is a protease, a lipase, a DNase, a hexosaminidases (e.g., a dispersin), and/or combination thereof.

### Builders and Co-Builders

The cleaning composition may contain about 0-65% by weight of a detergent builder or co-builder, or a mixture thereof. In a dish wash detergent, the level of builder is typically 40-65%, particularly 50-65%. The builder and/or co-builder may particularly be a chelating agent that forms water-soluble complexes with Ca2+ and Mg2+. Any builder and/or co-builder known in the art for use in laundry detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), disilicates, ethanolamines such as 2-aminoethan-1-ol (MEA), iminodiethanol (DEA) and 2,2′,2″-nitrilotriethanol (TEA), and carboxymethylinulin (CMI), and combinations thereof.

The detergent composition may also contain 0-65% by weight of a detergent co-builder, or a mixture thereof. The detergent composition may include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), etheylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N, N-diacetic acid (GLDA), 1-hydroxyethane-1,1-diylbis(phosphonic acid) (HEDP), ethylenediaminetetrakis(methylene)tetrakis(phosphonic acid) (EDTMPA), diethylenetriaminepentakis(methylene) pentakis (phosphonic acid) (DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N, N-diacetic acid (ANDA), sulfanilic acid-N, N-diacetic acid (SLDA), taurine-N, N-diacetic acid (TUDA) and sulfomethyl-N,N-diacetic acid (SMDA), N-(hydroxyethyl)-ethylidenediaminetriacetate (HEDTA), diethanolglycine (DEG), Diethylenetriamine Penta (Methylene Phosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053.

### Bleaching Systems

The detergent may contain 0-40% by weight, such as about 5% to about 25%, of a bleaching system. Any bleaching system known in the art for use in laundry detergents may be utilized. Suitable bleaching system components include bleaching catalysts, photobleaches, bleach activators, sources of hydrogen peroxide such as sodium percarbonate and sodium perborates, preformed peracids and mixtures thereof.

### Polymers

The detergent may further contain 0-10% by weight, such as 0.5-5%, 2-5%, 0.5-2% or 0.2-1% of another type of polymer. The polymer may function as a co-builder as mentioned above, or may provide soil release and grease cleaning properties. Some polymers may have more than one of the above-mentioned properties and/or more than one of the below-mentioned motifs. Any polymer known in the art for use in detergents may be utilized.

### Methods

Another aspect of the present invention relates to a method for cleaning a surface, comprising: (a) foaming (e.g., spraying or brush application) any one of the cleaning compositions of the invention onto said surface; and optionally (b) rinsing the surface.

Further aspect of the invention concerns a method for formulating a composition having reduced aerosolization (e.g., enzyme aerosolization), comprising mixing at least one primary surfactant and at least one secondary surfactant as described in the above surfactant section, and optionally adding at least one enzyme.

### Application System for Foam Generation

Typically, foams can be generated using a pressurized system and either applied as e.g., a spray or through a brush. Applying the foam as a spray may generate more aerosolized enzymes than a brush. In the foaming brush application, the foam is generated before exiting the brush thus, aerosolization of enzymes is minimized. Thus, for a spray application, both the primary surfactant and the secondary surfactant are ideally low-volatilizing surfactants so as to reduce safety (allergy) risks. A skilled person in the art can prepare suitable cleaning composition according to the concept of the invention for different foam generation system.

### Formulation of Enzyme in Co-Granule

The enzyme of the invention may be formulated as a granule for example as a co-granule that combines one or more enzymes. Each enzyme will then be present in more granules securing a more uniform distribution of enzymes in the detergent. This also reduces the physical segregation of different enzymes due to different particle sizes. Methods for producing multi-enzyme co-granulates for the detergent industry are disclosed in the IP.com disclosure IPCOM000200739D.

Another example of formulation of enzymes by the use of co-granulates is disclosed in WO 2013/188331, which relates to a cleaning composition comprising (a) a multi-enzyme co-granule; (b) less than 10 wt zeolite (anhydrous basis); and (c) less than 10 wt phosphate salt (anhydrous basis), wherein said enzyme co-granule comprises from 10 to 98 wt % moisture sink component and the composition additionally comprises from 20 to 80 wt % detergent moisture sink component. WO 2013/188331 also relates to a method of treating and/or cleaning a surface, comprising the steps of (i) contacting said surface with the cleaning composition as claimed and described herein in an aqueous wash liquor, (ii) rinsing and/or drying the surface.

The multi-enzyme co-granule may comprise an enzyme of the invention and one or more enzymes selected from the group consisting of lipases, amylases, hemicellulases, peroxidases, xylanases, phospholipases, esterases, cutinases, keratinases, reductases, oxidases, phenoloxidases, lipoxygenases, ligninases, pullulanases, malanases, β-glucanases, arabinosidases, hyaluronidase, laccase, deoxyribonucleases (DNases), hexosaminidases, and any mixture thereof.

The present invention is further summarised in the below paragraphs:
1. A cleaning composition having reduced aerosolization property, comprising:
   (i) at least one primary surfactant, wherein the primary surfactant has 8 to 12, e.g., 8-10 or 10-12 carbon units;
   (ii) at least one secondary surfactant, wherein the secondary surfactant has 8 to 16, e.g., 8-10, 10-12 or 10-14 carbon units; and optionally
   (iii) a buffering system.
2. The composition of paragraph 1, wherein the primary surfactant is selected from the group consisting of sodium, potassium, or ammonium salts and mixture thereof.
3. The composition of paragraph 1 or 2, wherein the secondary surfactant is selected from the group consisting of having 10 to 12 carbon units, and preferably selected from the group of consisting of amine oxides, betaines, primary fatty alcohols, monoethanolamides, diethanolamides, and mixture thereof.
4. The composition of any of preceding paragraphs, wherein the primary surfactant is a low-volatilizing surfactant.
5. The composition of paragraphs 4, wherein the secondary surfactant is a low-volatilizing surfactant.
6. The composition of any of paragraphs 4 or 5, wherein the volatility of the surfactant is evaluated by the particle aerosolization according to Example 2.
7. The composition of any of preceding paragraphs, wherein the secondary surfactant has same carbon units as the primary surfactant.
8. The composition of any of preceding paragraphs, wherein the primary surfactant comprises one or more anionic surfactants, e.g., linear alkylbenzenesulfonic acid (LAS), alcohol ethersulfate (AEOS) and/or alkyl sulfate (AS), in particular sodium lauryl sulfate (SLS), sodium laureth sulfate, sodium lauryl ether sulfate, ammonium decyl ether sulfate, sodium decyl sulfate, ammonium alkyl ether sulfate and sodium dodecyl sulfate.
9. The composition of any of preceding paragraphs, wherein the primary surfactant comprises one or more nonionic surfactants.
10. The composition of any of preceding paragraphs, wherein the secondary surfactant is selected from amine oxide, decylamine oxide, lauramine oxide and mixture thereof, and may optionally comprise a primary fatty alcohols such as 1-dodecaol and 1-decanol.
11. The composition of any of preceding paragraphs, wherein the primary surfactant is present in the composition at a level of from 0.2 to 60 wt %, from 0.5 to 40 wt %, from 0.8 to 30 wt %, from 1 to 50 wt %, from 1 to 40 wt %, from 1 to 30 wt %, from 1 to 20 wt %, from 3 to 10 wt %, from 3 to 5 wt %, from 5 to 40 wt %, from 5 to 30 wt %, from 5 to 15 wt %, from 2 to 20 wt %, from 3 to 6 wt %, from 8 to 12 wt %, from 10 to 12 wt %, from 20 to 25 wt % or from 25-60%.
12. The composition of any of preceding paragraphs, wherein the secondary surfactant is present in the composition at a level of from 0.01 to 10 wt %, from 0.02 to 8 wt %, from 0.05 to 6 wt %, from 0.1 to 5 wt %, from 0.5 to 4 wt %, from 1 to 3 wt %, from 1.5 to 8 wt %, or from 2 to 6 wt %.
13. The composition of any of preceding paragraphs, wherein the ratio of the secondary surfactant to the primary surfactant by weight is in the range of 0.001-1, e.g., in the range of 0.005-0.9, in the range of 0.01-0.8, in the range of 0.1-0.6, in the range of 0.08-0.5, or in the range of 0.2-0.4.
14. The composition of any of preceding paragraphs, wherein the buffering system comprises TRIS-HCl/TRIS-base, citric acid/citrate, sodium carbonate/sodium bicarbonate, or potassium carbonate/potassium bicarbonate. 15. The composition of any of preceding paragraphs, wherein the buffering system is comprised at a level of 0.02 to 10 wt %, e.g., from 0.05 to 8 wt %, from 0.1 to 6 wt %, from 0.5 to 5 wt %, from 1 to 4 wt %, from 2 to 6 wt % or from 3 to 5 wt %.
16. The composition of any of preceding paragraphs, wherein the composition further comprising one or more enzymes selected from the group consisting of protease, lipase, amylases, cellulases, mannanases, pectinases, hemicellulases, peroxidases, xylanases, phospholipases, xyloglucanases, esterases, cutinases, laccase, keratinases, reductases, oxidases, phenoloxidases, lipoxygenases, ligninases, pullulanases, malanases, ß-glucanases, arabinosidases, hyaluronidase, deoxyribonucleases (DNases), RNase, hexosaminidases, peroxidases, and any mixture thereof.
17. The composition of any of preceding paragraphs, wherein the enzyme is a protease, a lipase, a DNase, a hexosaminidases (e.g., a dispersin), and/or combination thereof.
18. The composition of any of preceding paragraphs, wherein the enzyme is a mixture or blend of a protease, a DNase and a hexosaminidases (e.g., a dispersin).
19. The composition of any of preceding paragraphs, wherein the protease has at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99% or 100% sequence identity to the polypeptide of SEQ ID NO: 1 or 2.
20. The composition of any of preceding paragraphs, wherein the protease is a variant of the polypeptide of SEQ ID NO: 2 comprising an alteration at one or more positions corresponding to positions 3, 4, 9, 15, 43, 68, 76, 99, 101, 103, 104, 160, 167, 170, 194, 199, 205, 206, 209, 217, 218, 222, 245, 261 and 262, wherein position numbers correspond to the positions of SEQ ID NO: 1, wherein each alteration is independently a substitution, deletion or insertion, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to the polypeptide of SEQ ID NO: 2.
21. The composition of any of preceding paragraphs, wherein the protease is:
   (a) a variant of the polypeptide of SEQ ID NO: 2, comprising one or more substitutions selected from the group consisting of: S3T, V4I, S9E, S9R, A15T, V68A, N76D, S99D, S99G, S99A, S99SE, S101E, S101N, S101R, S103A, V104I, G160S, Y167A, R170S, A194P, V199M, V205I, Q206L, Y209W, L217D, L217Q, N218D, M222S, Q245R, N261W and L262E, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, at least 99%, but less than 100% sequence identity to SEQ ID NO: 2;
   (b) a variant of the polypeptide of SEQ ID NO: 2, comprising the substitution S87N, wherein the variant has protease activity and wherein the position corresponds to the position of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2;
   (c) a variant of the polypeptide of SEQ ID NO: 2, comprising the substitutions Y167A+R170S+A194P, wherein position numbers correspond to the positions of SEQ ID NO: 1, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2;
   (d) a variant of the polypeptide of SEQ ID NO: 2, comprising the substitutions S9E+N43R+N76D+V205I+Q206L+Y209W+S259D+N261W+L262E, wherein position numbers correspond to the positions of SEQ ID NO: 1, and wherein the variant has protease activity and has at least 80, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 2;
   (e) a variant of the polypeptide of SEQ ID NO: 4, comprising the substitutions A68S+T77N+T781+G127S+A128P+G165Q+N184Q+A202V+N217S+S258P, wherein position numbers correspond to the positions of SEQ ID NO: 4, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 4;
   (f) a variant comprising a substitution at one or more positions corresponding to positions 171, 173, 175, 179 or 180 of SEQ ID NO: 1 of WO2004/067737, wherein the variant has protease activity and has a sequence identity of at least 80%, at least 85%, at least 90%, at least 91%, at least 92%, at least 93%, at least 94%, at least 95%, at least 96%, at least 97%, at least 98%, or at least 99%, but less than 100% to SEQ ID NO: 1 of WO2004/067737;
   (g) a protease variant comprising one or more substitutions compared to a parent protease, selected from the group consisting of X3V, X9 [E,R], X22 [R,A], X43R, X61 [E,D], X62 [E,D], X76 [D], X87N, X101 [E,G,D,N,M], X103A, X104I, X118 [V,R], X120V, X128 [A, L,S], X129Q, X130A, X160D, X185 [E,D], 188 [E,D], X191N, X194P, X205I, X206L, X209W, X216V, X217 [Q,D,E], X218 [D,E,S], X232V, X245R, X248D, X256 [E,D], X259 [E,D], X261 [E,D,W] and X262 [E,D], wherein position numbers correspond to the positions of BPN′ (SEQ ID NO: 1), wherein “X” represents any amino acid residue present in the specified position in the parent protease, and wherein the variant has protease activity and has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 1 or SEQ ID NO: 2; and
   (h) a protease variant comprising any of the following substitution sets compared to a parent protease, wherein the parent protease has the amino acid sequence of SEQ ID NO: 1 or SEQ ID NO: 2 or has at least 80% sequence identity to SEQ ID NO: 1 or SEQ ID NO: 2, wherein position numbers correspond to the positions of BPN′ (SEQ ID NO: 1), wherein “X” represents any amino acid residue present in the specified position in the parent protease, and wherein the substitution set is selected from the group consisting of:

$$i . X 9 R + X 15 T + X 68 A + X 218 D + X 245 R ,$$

$$ii . X 9 R + X 15 T + X 68 A + X 245 R ,$$

$$iii . X 61 E + X 194 P + X 205 I + X 261 D ,$$

$$iv . X 61 D + X 205 I + X 245 R ,$$

$$v . X 61 E + X 194 P + X 205 I + X 261 D ,$$

$$vi . X 87 N + X 118 V + X 128 L + X 129 Q + X 130 A ,$$

$$vii . X 87 N + X 101 M + X 118 V + X 128 L + X 129 Q + X 130 A ,$$

$$viii . X76 D + X 87 R + X 118 R + X 128 L + X 129 Q + X 130 A ,$$

$$ix . X 22 A + X 62 D + X 101 G + X 188 D + X 232 V + X 245 R ,$$

$$x . X 103 A + X 104 I ,$$

$$xi . X 22 R + X 101 G + X 232 V + X 245 R ,$$

$$xii . X 103 A + X 104 I + X 156 D ,$$

$$xiii . X 103 A + X 104 I + X 261 E ,$$

$$xiv . X 62 D + X 245 R ,$$

$$xv . X 101 N + X 128 A + X 217 Q ,$$

$$xvi . X 101 E + X 217 Q ,$$

$$xvii . X 101 E + X 217 D ,$$

$$xviii . X 9 E + X 43 R + X 262 E ,$$

$$xix . X 76 D + X 43 R + X 209 W ,$$

$$xx . X 205 I + X 206 L + X 209 W ,$$

$$xxi . X 185 E + X 188 E + X 205 I ,$$

$$xxii . X 256 D + X 261 W + X 262 E ,$$

$$xxiii . X 191 N + X 209 W ,$$

$$xxiv . X 261 E + X 262 E ,$$

$$xxv . X 261 E + X 262 D , and$$

$$xxvi . X 167 A + X 170 S + X 1 \; 94 P ,$$

wherein the protease variant has at least 80%, at least 85%, at least 90%, at least 91%, at least 92%, at least 93%, at least 94%, at least 95%, at least 96%, at least 97%, at least 98%, or at least 99%, but less than 100% sequence identity to SEQ ID NO: 1 or 2.
22. The composition of any of preceding paragraphs, wherein the protease variant comprises the amino acid sequence of SEQ ID NO: 2 with the substitutions Y167A+R170S+A194P, wherein the variant has protease activity, and wherein position numbers correspond to the positions of SEQ ID NO: 1.
23. The composition of any of preceding paragraphs, wherein the protease variant comprises the amino acid sequence of SEQ ID NO: 2 with the substitutions S9E+N43R+N76D+V205I+Q206L+Y209W+S259D+N261W+L262E, wherein the variant has protease activity and wherein position numbers correspond to the positions of SEQ ID NO: 1.
24. The composition of any of preceding paragraphs, wherein when the composition is evaluated by the 20-minute foam test according to Example 1, the volume of particles sized at 0.3 μm is no more than 15×10⁶ m³, e.g., below 10×10⁶ m³, 8×10⁶ ms³, 6×10⁶ m³, 5×10⁶ m³, or 2×10⁶ m³.
25. The composition of any of preceding paragraphs, wherein when the composition is evaluated by the 20-minute foam test according to Example 1, the volume of particles sized at 0.5 μm is no more than 15×10⁶ m³, e.g., below 10×10⁶ m³, 8×10⁶ m³, 6×10⁶ m³, 5×10⁶ m³, or 2×10⁶ m³.
26. The composition of any of preceding paragraphs, wherein when the composition is evaluated by the 20-minute foam test according to Example 1, the volume of particles sized at 1 μm is no more than 15×10⁶ m³, e.g., below 10×10⁶ m³, 8×10⁶ m³, 6×10⁶ m³, 5×10⁶ m³, or 2×10⁶ m³.
27. The composition of any of preceding paragraphs, wherein when the composition is evaluated by the 20-minute foam test according to Example 1, the volume of particles sized at 2 μm is no more than 15×10⁶ m³, e.g., below 10×10⁶ m³, 8×10⁶ m³, 6×10⁶ m³, 5×10⁶ m³, or 2× 106 m³.
28. The composition of any of preceding paragraphs, wherein when the composition is evaluated by the method according to Example 2, the enzyme aerosolization concentration is no more than 100 ppb, e.g., no more than 80 ppb, no more than 60 ppb, no more than 50 ppb, no more than 30 ppb, no more than 20 ppb, no more than 15 ppb or no more than 10 ppb.
29. The composition of any of preceding paragraphs, wherein the surface tension of the composition is 35 mN/m or lower, 30 mN/m or lower, 28 mN/m or lower, 25 mN/m or lower or 20 mN/m or lower.
30. The composition of any of proceeding composition paragraphs, wherein said composition is formulated suitable for foam type cleaner, and preferably has a pH of below 11, e.g., in the range of 6-9.5, in the range of 6.5-9, in the range of 6.8-8.5, or in the range of 7-8, more preferably have a neutral pH of 6.5-7.5, such as pH 7.0, 7.1 or 7.
31. The composition of any of proceeding paragraphs, wherein said composition further comprises a preservative e.g., 2-Phenoxyethanol, isothiazolionones (such as Benzisothiazolinone (BIT), Methylisothizolinone (MIT), Chloromethylisothiazolinone (CMIT)) or mixtures thereof.
32. The composition of paragraph 31, wherein the preservative comprises 2-Phenoxyethanol.
33. The composition of paragraph 31 or 32, wherein the preservative is present in the composition at a level of from 0.01 to10 wt %, from 0.1 to 5 wt %, from 0.5 to 3 wt %, or from 1 to 2 wt %.
34. The composition of any of proceeding paragraphs, wherein said composition further comprises an enzyme stabilizer selected from a group consisting of glycerol, sorbitol, sucrose, glucose, NaCl, KCl, sodium formate, citric acid, sodium citrate tribasic dihydrate, hexanediol, heptandiol, PEG 300, and PEG 600, and the mixture thereof.
35. The composition of paragraph 34, wherein the enzyme stabilizer comprises glycerol and/or PEG 600.
36. The composition of paragraph 34 or 35, wherein the enzyme stabilizer is present in the composition at a level of from 0.5 to 25 wt %, from 1 to 20 wt %, from 2 to 18 wt %, from 4 to 15 wt %, or from 5 to 10 wt %.
37. The composition of any of proceeding paragraphs, wherein the composition is formulated as a ready-to-use detergent or as a concentrate (e.g., 2×, 5×, 10× or 15× concentrated) detergent.
38. The composition of paragraph 37, wherein the concentrate detergent comprises an ammonium alkyl ether sulfate, and a secondary surfactant selected from lauramine oxides, linear alcohol (c12-13) ethoxylate (e.g., linear alcohol (c12-13) ethoxylate poe-3), and the mixture thereof.
39. A method for cleaning a surface, comprising: (a) foaming (e.g., by spraying or brush application) any one of the cleaning compositions as defined in any of preceding paragraphs 1-38 onto said surface; and optionally (b) rinsing the surface, preferably said surface is a hard surface.
40. A method for formulating a composition having reduced aerosolization (e.g., enzyme aerosolization), comprising mixing at least one primary surfactant and at least one secondary surfactant as defined in any of proceeding paragraphs, and optionally adding at least one enzyme.

The invention is further illustrated in the following non-limiting examples.

### Examples

### Assay I

### Testing of Protease Activity

Proteolytic activity can be determined by a method employing the Suc-AAPF-pNA substrate. Suc-AAPF-pNA is an abbreviation for N-Succinyl-Alanine-Alanine-Proline-Phenylalanine-p-Nitroanilide, and is a blocked peptide which can be cleaved by endo-proteases. Following proteolytic cleavage, a free pNA molecule having a yellow color is liberated and can be measured by visible spectrophotometry at wavelength 405 nm. The Suc-AAPF-PNA substrate is manufactured by Bachem (cat. no. L1400, dissolved in DMSO).

The protease sample to be analyzed is diluted in residual activity buffer (100 mM Tris pH 8.6). The assay is performed by transferring 30 μl of diluted enzyme samples to 96 well micro-titer plate and adding 70 μl substrate working solution (0.72 mg/ml in 100 mM Tris pH 9). The solution is mixed at room temperature and absorption is measured every 20 sec. over 5 minutes at OD 405 nm.

The slope (absorbance per minute) of the time dependent absorption-curve is directly proportional to the activity of the protease in question under the given set of conditions. The protease sample should be diluted to a level where the slope is linear.

### Assay II

### Testing of DNase Activity

DNase activity may be determined on DNase Test Agar with Methyl Green (BD, Franklin Lakes, NJ, USA), which is prepared according to the supplier's manual. Briefly, 21 g of agar is dissolved in 500 ml water and then autoclaved for 15 min at 121° C. Autoclaved agar is tempered to 48° C. in a water bath, and 20 ml of agar is poured into petri dishes and allowed to solidify by incubation overnight at room temperature. On solidified agar plates, 5 μl of enzyme solutions are added, and DNase activity is observed as colorless zones around the spotted enzyme solutions.

### Assay III

### Testing of Hexosaminidase Activity

Hexosaminidase activity may be determined using 4-nitrophenyl N-acetyl-β-D-glucosaminide (Sigma-Aldrich) as a substrate. The enzymatic reaction is performed in triplicate in a 96 well flat bottom polystyrene microtiter plate (Thermo Scientific) with the following conditions: 50 mM 2-(N-morpholino) ethanesulfonic acid pH 6 buffer, 1.5 mg/ml 4-nitrophenyl N-acetyl-β-D-glucosaminide and 10, 20 or 50 μg/ml purified enzyme sample in a total reaction volume of 100 μl. Blank samples without polypeptide are run in parallel. The reactions are carried out at 37° C. in a Thermomixer comfort (Eppendorf). After 10 minutes of incubation, 5 μl 1 M NaOH is added to each reaction mixture to stop the enzymatic reaction. The absorbance is read at 405 nm using a POLAR star Omega plate reader (BMG LABTECH) to estimate the formation of 4-nitrophenolate ion released because of enzymatic hydrolysis of the 4-nitrophenyl N-acetyl-β-D-glucosaminide substrate. A measured absorbance of the reaction carried out with a hexosaminidase polypeptide that is higher than that of blanks without a polypeptide indicates that the tested polypeptide exhibits hexosaminidase activity.

### Assay IV

Lipase Activity Determined by p-Nitrophenyl (pNP) Assay

The hydrolytic activity of lipases may be determined by a kinetic assay using p-nitrophenyl acyl esters as substrate. A 100 mM stock solution in DMSO for each of the substrates p-nitrophenyl butyrate (C₄), p-nitrophenyl caproate (C6), p-nitrophenyl caprate (C10), p-nitrophenyl laurate (C12) and p-nitrophenyl palmitate (C16) (all from Sigma-Aldrich Danmark A/S, Kirkebjerg Alle 84, 2605 Brøndby; Cat. no.: C3: N-9876, C6: N-0502, C10: N-0252, C12: N-2002, C16: N-2752) is diluted to a final concentration of 1 mM 25 mM in the assay buffer (50 mM Tris; pH 7.7; 0.4% Triton X-100). The lipase in 50 mM Hepes; pH 8.0; 10 ppm Triton X-100; +/−20 mM CaCl₂) are added to the substrate solution in the following final protein concentrations: 0.01 mg/ml; 5×10−3 mg/ml; 2.5×10−4 mg/ml; and 1.25×10−4 mg/ml in 96-well NUNC plates (Cat. No. 260836, Kamstrupvej 90, DK-4000, Roskilde). Release of p-nitrophenol by hydrolysis of a p-nitrophenyl acyl may be monitored at 405 nm for 5 minutes in 10 second intervals on a Spectra max 190 (Molecular Devices GmbH, Bismarckring 39, 88400 Biberach an der Riss, GERMANY).

### Detergents

TABLE 1
Detergent compositions

| | | Secondary | |
|---|---|---|---|
| | Primary Surfactant | Surfactant | Other ingredients |
| Detergent 1 | 0.25% w/w active | 0.05% w/w | 1% w/w TRIS 2M buffer |
| | sodium lauryl sulfate | 1-dodecanol | (Sigma-Aldrich) |
| | (Sigma-Aldrich, 100% | (Sigma Aldrich) | 0.125% w/w magnesium |
| | actives) | | sulfate heptahydrate |
| | | | (Sigma-Aldrich) |
| Detergent 2 | 1.44% w/w (or 0.431% | 0.14% w/w | / |
| | active) sodium lauryl | 1-dodecanol | |
| | sulfate (Stepan, | (Sigma Aldrich); | |
| | Stepanol WA-Extra | 0.14% w/w | |
| | PCK, 29% actives); | 1-decanol | |
| | 1.44% w/w (or 0.431% | (Sigma Aldrich) | |
| | active) sodium decyl | | |
| | sulfate (Stepan, | | |
| | Polystep B-25, | | |
| | 38% actives) | | |
| Detergent 3 | 1.44% w/w (or 0.431% | 0.14% w/w | / |
| | active) sodium lauryl | 1-dodecanol | |
| | sulfate (Stepan, | (Sigma Aldrich) | |
| | Stepanol WA-Extra | | |
| | PCK, 29% actives); | | |
| | 1.44% w/w (or | | |
| | 0.431% active) sodium | | |
| | decyl sulfate (Stepan, | | |
| | Polystep B-25, | | |
| | 38% actives) | | |
| Detergent 4 | 0.565% active w/w | 0.13% w/w active | / |
| | sodium lauryl sulfate | decylamine oxide | |
| | (Stepan, Stepanol | (Stepan, Ammonyx | |
| | WA-EXTRA PCK, | DO, 30% actives) | |
| | 29% actives); | | |
| | 0.304% w/w active | | |
| | sodium decyl sulfate | | |
| | (Stepan, Polystep | | |
| | B-25, 38% actives) | | |
| Detergent 5 | 0.75% w/w (or 0.435% | 0.435% w/w (0.13% | / |
| | active) ammonium | w/w active) | |
| | decyl ether sulfate | decylamine oxide | |
| | (Pilot Chemical, | (Stepan, Ammonyx | |
| | Calfoam EA-682, | DO, 30% actives) | |
| | 58% actives), | | |
| | 0.435% w/w active | | |
| | sodium laureth sulfate, | | |
| | 1 mole EO (Stepan, | | |
| | Steol CS-130, | | |
| | 25% actives) | | |
| Detergent 6 | 0.562% w/w (or | 0.217% w/w (0.065% | / |
| | 0.326% w/w active) | w/w active) | |
| | ammonium decyl ether | decylamine oxide | |
| | sulfate (Pilot | (Stepan, Ammonyx | |
| | Chemical, | DO, 30% actives) | |
| | Calfoam EA-682, | | |
| | 58% actives); | | |
| | 0.362% w/w (0.109% | | |
| | w/w active) sodium | | |
| | lauryl sulfate | | |
| | (Stepanol | | |
| | WA-EXTRA PCK, | | |
| | 29% actives) | | |
| Detergent 7 | 2.89% w/w (0.87% | 0.217% w/w (0.065% | / |
| | w/w active) sodium | w/w active) | |
| | laurel sulfate | lauramine oxide | |
| | (Stepan, | (Stepan, Ammonyx | |
| | Stepanol WA-EXTRA | LO, 30% actives) | |
| | PCK, 29% actives),. | 0.065% w/w active | |
| | | linear alcohol (c12-13) | |
| | | ethoxylate poe-3 | |
| | | (Stepan, Bio-Soft | |
| | | N23-3) | |
| Detergent 8 | 22.5% w/w active | 5.625% w/w active | 0.05% w/w citric acid |
| (15X | ammonium alkyl ether | lauramine oxide | (Sigma Aldrich); |
| concentrate) | sulfate c8-10 (Stepan, | (Stepan, Ammonyx | 0.45% w/w sodium |
| | Cedepal FA-406, | LO, 30% actives), | citrate tribasic |
| | 59% actives) | 1.875% w/w active | dihydrate |
| | | linear alcohol (c12-13) | (Sigma Aldrich); |
| | | ethoxylate poe-3 | 5% w/w glycerol |
| | | (Stepan, Bio-Soft | (Nature's oil); |
| | | N23-3, 100% actives) | |
| Detergent 9 | 22.5% w/w active | 5.625% w/w active | 0.05% w/w citric |
| (15X | ammonium alkyl ether | lauramine oxide | acid |
| concentrate) | sulfate c8-10 (Stepan, | (Stepan, Ammonyx | (Sigma Aldrich); |
| | Cedepal FA-406, | LO, 30% actives) | 0.45% w/w sodium |
| | 59% actives) | 1.875% w/w active | citrate tribasic |
| | | linear alcohol (c12-13) | dihydrate |
| | | ethoxylate poe-3 | (Sigma Aldrich); |
| | | (Stepan, Bio-Soft | 10% w/w glycerol |
| | | N23-3, 100% actives) | (Nature's oil); |
| | | | 4% w/w PEG 600 |
| | | | (CARBOWAX) |

### Enzymes Used in Below Examples

Protease: polypeptide of SEQ ID NO: 2 with the following mutations: Y167A+R170S+A194P, wherein position numbers are based on the numbering of SEQ ID NO: 1.

Nuclease: polypeptide of SEQ ID NO: 3 with the following mutations: T11+S13Y+T22P+S27L+L33K+S39P+S42G+D561+S57W+S59V+T65V+V76L+Q109R+S116D+T127V+S144P+A147H+S167L+G175D.

Hexosaminidase: polypeptide of SEQ ID NO: 4 with the following mutations: Q31+H15Y+A49W+N59E+S163P+S186R+S225G+N227T+E232D+G235W+N252P+N260Q+H272V+S279D+Y281P+K308Q+K309E+K312Q.

### Example 1-Reduced Particle Aerosolization Cleaning Composition of the Invention

Studies were performed to assess the reduction of particle aerosolization of a detergent composition of the invention.

### Test Procedure

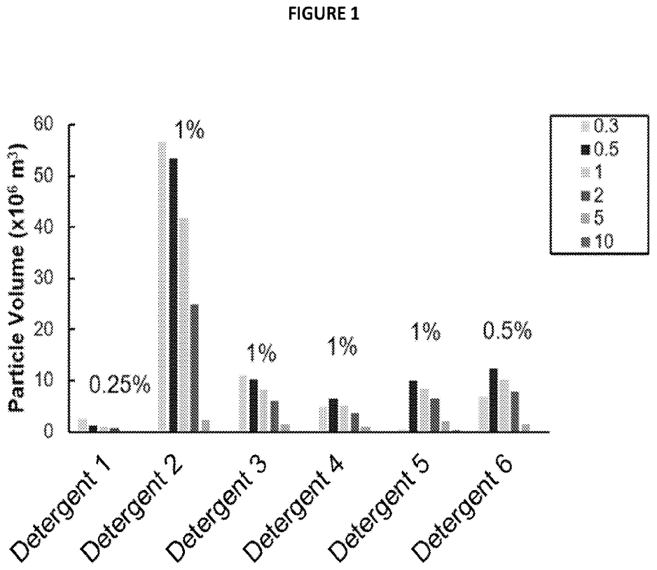

The particle distribution of six detergents was assessed. For this test, particle distribution was used as an indirect measure of enzyme aerosolization. Detergents were sprayed onto a wall in an enclosed area using a 5-gallon smart foam unit (Foamlt) for 20 minutes. A large particle count indicated that the detergent easily created aerosolized particles and would be a bad detergent to use for enzyme testing. Conversely, a low particle count indicated that the detergent did not aerosolize and would be a good detergent candidate. The following data was collected. Particle counts were measured using (Bench-Top Particle Counter, Met One Instruments, Grants Pass OR). The volume (m³) of particles sized at 0.3, 0.5, 1, 2, 5, 10 μm was recorded for the 20-minute test. The distribution of particles generated was plotted for each detergent, as shown in FIG. 1.

It can be seen from FIG. 1 that Detergent 2, which contains two different secondary surfactants with a relative higher concentration, generated the greatest volume of total particles. Conversely, Detergent 1, 3, 4, 5 and 6 generated much decreased total volume of particles. A possible reason for this difference might relate to the volatility (or atomization) of the chemicals used in the detergent. Surfactants such as aliphatic primary linear alcohols will rapidly volatilize (or atomize) in a foam application, pulling more particles into the air. These findings suggest that suitable detergents should contains low amount of or be free of volatile surfactants.

In addition, sodium lauryl sulfate (SLS) is more cohesive than sodium dodecyl sulfate (SDS) due to higher molecular weight, thus SLS leads to less volatilization. Additionally, SLS has stronger interaction with fatty alcohols than SDS. This may explain why Detergent 1 is so low on particle dispersion compared to Detergent 3; Detergent 1 assess particle dispersion using SLS and fatty alcohol, and Detergent 3 assess SDS with fatty alcohols. Thus, SLS or the like is a preferred primary surfactant when a volatile secondary surfactant is used and is considered as a suitable primary surfactant for applications where on-site mixing (enzymes added to chemistry right before use) is possible.

### Example 2-Reduced Enzyme Aerosolization Mode of Application of the Invention

Studies were performed to assess the reduction of enzyme aerosolization of the mode of application of the invention comprising of subtilisin protease (polypeptide of SEQ ID NO: 2 with the following mutations: Y167A+R170S+A194P, wherein position numbers are based on the numbering of SEQ ID NO: 1). The protease is present in Detergent 7 at 15 and 30 ppm active enzyme protein (AEP) concentration.

### Test Procedure

Four different modes of foam application were assessed:

Application 1: Foam unit with heavy duty trigger gun (Foamlt).

Application 2: Smart foam unit (Foamlt) with foam spray nozzle.

Application 3: Smart foam unit (Foamlt) with a brush head configuration #1 (Lowes).

Application 4: Smart foam unit (Foamlt) with brush head configuration #2 (Lowes).

For each test, foam was applied to a wall in an enclosed area using one of the application modes for 20 minutes. During the time, the following data was collected:
1) Particle counts were measured using (Bench-Top Particle Counter, Met One Instruments, Grants Pass OR). The volume (m³) of particles sized at 0.3, 0.5, 1, 2, 5, 10 μm was recorded for the 20-minute test. The distribution of particles generated was plotted for each detergent.
2) Enzyme air concentrations. Pumps pulled air through a filter at a rate of 25 L min⁻¹. Filter collected aerosolized enzymes from the foam application. Filters were analyzed using MICT with the target enzyme protease for detection. The resulting enzyme concentrations were plotted against the particle distribution and grouped by application mode.

TABLE 2
Enzyme aerosolization concentration versus the rate of
particles generated by foam application type. Detergents
4, 6, and 7 were evaluated by Applications 2. Detergent
7 was further analyzed by Application 1, 3 and 4.

| | | Enzyme | Particle | Enzyme |
|---|---|---|---|---|
| | | Concentration | Dispersion | Aerosolization |
| Deter- | Appli- | in Detergent | Rate | concentra- |
| gent | cation | (ppm) | (m³ sec⁻¹) | tion (ppb) |
| 7 | 4 | 15 | 0.17 | 3.2 |
| 7 | 4 | 30 | 0.21 | 4.1 |
| 7 | 3 | 15 | 0.32 | 3.0 |
| 7 | 3 | 30 | 0.36 | 8.0 |
| 7 | 2 | 30 | 1.28 | 130 |
| 6 | 2 | 30 | 1.45 | 193 |
| 4 | 2 | 30 | 2.47 | 246 |
| 7 | 1 | 30 | 5.98 | 425 |

In general, detergents of the present invention generated lower enzyme aerosolization than a traditional detergent. Table 2 shows that Detergent 7, as compared to the other two tested detergents (Detergent 4, 6), produced the least amount of enzyme aerosolization under all tested Applications 1-4.

### Example 3-Enzyme Stable Detergent Composition of the Invention

This example will determine the stability of enzyme detergent compositions of the invention.

Detergent 7 is appropriate for use as a ready-to-use formulation. Detergents 8 and 9 (see table 1) are both a 15× concentrated formula. For a concentrated product, primary surfactant may be adjusted because some concentrated primary surfactants (e.g., sodium laurel sulfate) may denature enzymes, rendering them inactive. For this reason, primary surfactant suitable for concentrated formula may be ammonium alkyl ether sulfate or the like.

Studies were conducted to determine the concentrations of stabilizers (such as citric acid, sodium citrate tribasic dihydrate, glycerol, and PEG 600) needed to create a stable, concentrated detergent for protease, nuclease, and carbohydrase enzymes. Stabilization is defined as the retainment of >80% enzymatic activity over an 8-week time-period.

Enzymes tested: (1) Enzyme blend (60% protease, 20% nuclease, 20% hexosaminidase); (2) single enzyme: nuclease. These sequence information of these enzymes are as described in the above Enzyme section.

### Testing Procedure:

As shown in below table 3, different combinations of enzyme stabilizers (glycerol and PEG 600) were assessed for the ability to provide enzyme stability. Each combination assessed the stability of a single nuclease enzyme, and a blend of protease, nuclease, and hexosaminidase for a total of 14 tests. Each test was subjected to 4 different temperatures (4° C., 25° C., 30° C. and 37° C.). The enzyme activity was measured at each temperature over the course of 2, 4, and 8 weeks (measured activity). A sample stored at −18° C. served as the control sample for the 2-, 4-, and 8-week time intervals (control activity). The reported enzyme activity for each temperature and time point was calculated as a percentage (%) of the measured activity to the control activity. Results are shown in below tables 4 and 5.

Table 3 below outlines the combinations on glycerol and PEG 600 assessed for the stability study. Combinations are referenced by “F”. Tables 4 and 5 summarize the stability results for an enzyme blend and a single enzyme. Based on Table 4, F13 provided adequate stability for 2-, 4-, and 8-week period at 4° C. and 25° C. From Table 5, it could be concluded that nuclease was stable in all test combinations (although less stable in F10 and F14 than in other combinations). F4 provided the best stability conditions for the nuclease enzyme at all temperatures and time points.

TABLE 3
tested combinations of different stabilizers
at different concentrations

| | Tested | Glycerol | PEG 600 |
|---|---|---|---|
| Enzyme | Combinations | (% w/w) | (% w/w) |
| Enzyme blend | F1 | 0% | 0% |
| | F3 | 5 | 0 |
| | F5 | 0 | 2 |
| | F7 | 10 | 0 |
| | F9 | 0 | 4 |
| | F11 | 5 | 2 |
| | F13 | 10 | 4 |
| Single enzyme | F2 | 0 | 0 |
| | F4 | 5 | 0 |
| | F6 | 0 | 2 |
| | F8 | 10 | 0 |
| | F10 | 0 | 4 |
| | F12 | 5 | 2 |
| | F14 | 10 | 4 |

TABLE 4
Stability results for enzyme blend in test combination F1, F3, F5, F7, F9, F11,
and F13, under 4° C., 25° C., 30° C. or 37° C.

| | | | 2 week | | | | | | | 4 week | | | |
|---|---|---|---|---|---|---|---|---|---|---|---|---|---|
| | | | F1 | F3 | F5 | F7 | F9 | F11 | F13 | F1 | F3 | F5 | F7 |
| Protease | 4 | C. | 69% | 72% | 69% | 63% | 66% | 71% | 100% | 48% | 55% | 42% | 58% |
| | 25 | C. | 9% | 11% | 8% | 12% | 10% | 12% | 99% | 9% | 8% | 7% | 7% |
| | 30 | C. | 5% | 5% | 6% | 5% | 6% | 6% | 90% | 5% | 5% | 5% | 6% |
| | 37 | C. | 4% | 2% | 5% | 3% | 5% | 2% | 62% | 5% | 5% | 6% | 4% |
| Nuclease | 4 | C. | 117% | 112% | 102% | 95% | 94% | 95% | 99% | 105% | 104% | 97% | 100% |
| | 25 | C. | 100% | 108% | 99% | 91% | 94% | 95% | 99% | 111% | 102% | 104% | 99% |
| | 30 | C. | 86% | 90% | 97% | 88% | 92% | 94% | 99% | 98% | 98% | 86% | 93% |
| | 37 | C. | 78% | [symbol] % | 77% | 85% | 81% | [symbol] 1% | 96% | [symbol] 0% | 81% | 72% | 77% |
| hexosaminidase | 4 | C. | 82% | 109% | 71% | 86% | 79% | 99% | 95% | 89% | 91% | 90% | 79% |
| | 25 | C. | 71% | 77% | 65% | 78% | 66% | 80% | 112% | 62% | 60% | 68% | 74% |
| | 30 | C. | 71% | 77% | 65% | 78% | 66% | 80% | 77% | 62% | 60% | 68% | 74% |
| | 37 | C. | 71% | 77% | 65% | 78% | 66% | 80% | 77% | 62% | 60% | 68% | 74% |

| | | | 4 week | | | 8 week | | | | | | |
|---|---|---|---|---|---|---|---|---|---|---|---|---|
| | | | F9 | F11 | F13 | F1 | F3 | F5 | F7 | F9 | F11 | F13 |
| Protease | 4 | C. | 47% | 53% | 101% | 28% | [symbol] % | 23% | 36% | 34% | 31% | 102% |
| | 25 | C. | 9% | 7% | 100% | 9% | 7% | 1% | 7% | 8% | 7% | 99% |
| | 30 | C. | 6% | 6% | 83% | 4% | 5% | 5% | 5% | 5% | 5% | 72% |
| | 37 | C. | 5% | 5% | 45% | 5% | 5% | 6% | 4% | 5% | 5% | 24% |
| Nuclease | 4 | C. | 101% | 9 [symbol] % | 96% | 103% | 10 [symbol] % | 101% | 100% | 95% | 90% | 108% |
| | 25 | C. | 91% | 90% | 106% | 100% | 10 [symbol] % | 91% | 96% | 91% | 88% | 102% |
| | 30 | C. | 90% | 81% | 105% | 85% | 89% | 80% | 83% | 78% | 72% | 109% |
| | 37 | C. | 74% | 69% | 93% | 61% | [symbol] % | 64% | 68% | 62% | 62% | 80% |
| hexosaminidase | 4 | C. | 96% | 67% | 100% | 84% | 88% | 89% | 83% | 81% | 67% | 101% |
| | 25 | C. | 81% | 67% | 98% | 62% | 50% | 68% | 74% | 81% | 67% | 98% |
| | 30 | C. | 81% | 67% | 98% | 62% | 60% | 68% | 74% | 81% | 67% | 98% |
| | 37 | C. | 81% | 67% | 98% | 62% | [symbol] 0% | 68% | 74% | 81% | 67% | 98% |

[symbol]

indicates data missing or illegible when filed

TABLE 5
Stability results for single enzyme in test combinations F2, F4, F6, F8, F10,
F12 under 4° C., 25° C., 30° C. or 37° C.

| | | 2 week | | | | | | | 4 week | | |
|---|---|---|---|---|---|---|---|---|---|---|---|
| | | F2 | F4 | F6 | F8 | F10 | F12 | F14 | F2 | F4 | F6 |
| Nuclease | 4 C. | 91% | 110% | 91% | 98% | 98% | 98% | 97% | 104% | 98% | 100% |
| | 25 C. | 97% | 118% | 95% | 95% | 98% | 98% | 102% | 94% | 100% | 94% |
| | 30 C. | 91% | 106% | 87% | 92% | 96% | 103% | 97% | 94% | 102% | 106% |
| | 37 C. | 87% | 102% | 81% | 94% | 96% | 90% | 98% | 91% | 98% | 92% |

| | | 4 week | | | | 8 week | | | | | | |
|---|---|---|---|---|---|---|---|---|---|---|---|---|
| | | F8 | F10 | F12 | F14 | F2 | F4 | F6 | F8 | F10 | F12 | F14 |
| Nuclease | 4 C. | 99% | 98% | 96% | 96% | 101% | 96% | 93% | 95% | 89% | 95% | 97% |
| | 25 C. | 94% | 95% | 95% | 92% | 107% | 100% | 102% | 98% | 94% | 99% | 89% |
| | 30 C. | 96% | 94% | 93% | 90% | 99% | 102% | 104% | 90% | 85% | 93% | 94% |
| | 37 C. | 91% | 82% | 92% | 92% | 89% | 91% | 81% | 89% | 74% | 84% | 76% |

1. A cleaning composition having reduced aerosolization property, comprising:
(i) at least one primary surfactant, wherein the primary surfactant has 8 to 12, e.g., 8-10 or 10-12 carbon units;
(ii) at least one secondary surfactant, wherein the secondary surfactant has 8 to 16, e.g., 8-10, 10-12 or 10-14 carbon units; and optionally
(iii) a buffering system.

2. The composition of claim 1, wherein the primary surfactant is selected from the group consisting of sodium, potassium, or ammonium salts and mixture thereof.

3. The composition of claim 1, wherein the secondary surfactant is selected from the group consisting of detergent surfactants having 10 to 12 carbon units, and preferably selected from the group consisting of amine oxides, betaines, primary fatty alcohols, monoethanolamides, diethanolamides, and mixtures thereof.

4. The composition of claim 1, wherein the volatility of the surfactant is evaluated by the particle aerosolization according to Example 2.

5. The composition of claim 1, wherein the secondary surfactant has same number of carbon units as the primary surfactant.

6. The composition of claim 1, wherein the primary surfactant comprises one or more anionic surfactants, e.g., linear alkylbenzenesulfonic acid (LAS), alcohol ethersulfate (AEOS) and/or alkyl sulfate (AS), in particular sodium lauryl sulfate (SLS), sodium laureth sulfate, sodium lauryl ether sulfate and sodium dodecyl sulfate, ammonium decyl ether sulfate, sodium decyl sulfate, and ammonium alkyl ether sulfate.

7. The composition of claim 1, wherein the secondary surfactant is selected from amine oxide, dedcylamine oxide, lauramine oxide and mixture thereof, and may optionally comprise a primary fatty alcohols such as 1-dodecaol and 1-decanol.

8. The composition of claim 1, wherein the primary surfactant is present at a level of from 0.2 to 60 wt %, from 0.5 to 40 wt %, from 0.8 to 30 wt %, from 1 to 50 wt %, from 1 to 40 wt %, from 1 to 30 wt %, from 1 to 20 wt %, from 3 to 10 wt %, from 3 to 5 wt %, from 5 to 40 wt %, from 5 to 30 wt %, from 5 to 15 wt %, from 2 to 20 wt %, from 3 to 6 wt %, from 8 to 12 wt %, from 10 to 12 wt %, from 20 to 25 wt % or from 25-60%.

9. The composition of claim 1, wherein the secondary surfactant is present at a level of from 0.01 to 10 wt %, from 0.02 to 8 wt %, from 0.05 to 6 wt %, from 0.1 to 5 wt %, from 0.5 to 4 wt %, from 1 to 3 wt %, from 1.5 to 8 wt %, or from 2 to 6 wt %.

10. The composition of claim 1, wherein the ratio of the secondary surfactant to the primary surfactant by weight is in the range of 0.001-1, e.g., in the range of 0.005-0.9, in the range of 0.01-0.8, in the range of 0.1-0.6, in the range of 0.08-0.5, or in the range of 0.2-0.4.

11. The composition of claim 1, wherein the buffering system comprises TRIS-HCl/TRIS-base or citric acid/citrate or sodium carbonate/sodium bicarbonate, potassium carbonate/potassium bicarbonate.

12. The composition of claim 1, wherein the buffering system is comprised at a level of 0.02 to 10 wt %, e.g., from 0.05 to 8 wt %, from 0.1 to 6 wt %, from 0.5 to 5 wt %, from 1 to 4 wt %, from 2 to 6 wt % or from 3 to 5 wt %.

13. The composition of claim 1, wherein the composition further comprises one or more enzymes selected from the group consisting of protease, lipase, amylases, cellulases, mannanases, pectinases, hemicellulases, peroxidases, xylanases, phospholipases, Xyloglucanase, esterases, cutinases, laccase, keratinases, reductases, oxidases, phenoloxidases, lipoxygenases, ligninases, pullulanases, malanases, ß-glucanases, arabinosidases, hyaluronidase, deoxyribonucleases (DNases), RNase, hexosaminidases, peroxidases, and any mixture thereof.

14. The composition of claim 1, wherein when the composition is evaluated by the 20-minute foam test according to Example 1, the volume of particles sized at 0.5 μm is no more than 15×10⁶ m³, e.g., below 10×10⁶ m³, 8×10⁶ m³, 6×10⁶ m³, 5×10⁶ m³, or 2×10⁶ m³.

15. The composition of claim 1, wherein when the composition is evaluated by the method according to Example 2, the enzyme aerosolization concentration is no more than 100 ppb, e.g., no more than 80 ppb, no more than 60 ppb, no more than 50 ppb, no more than 30 ppb, no more than 20 ppb, no more than 15 ppb or no more than 10 ppb.

16. The composition of claim 1, wherein the surface tension of the composition is 35 mN/m or lower, 30 mN/m or lower, 28 mN/m or lower, 25 mN/m or lower or 20 mN/m or lower.

17. A method for cleaning a surface, comprising: (a) foaming cleaning composition of claim 1 onto said surface; and optionally (b) rinsing the surface.

18. A method for formulating a composition having reduced aerosolization (e.g., enzyme aerosolization), comprising mixing at least one primary surfactant and at least one secondary surfactant and optionally a buffering system claim 1, and optionally adding at least one enzyme.

19. The method of claim 17, wherein the foaming comprises spraying.

20. The method of claim 17, wherein the surface is a hard surface.


SEQUENCE LISTING (4 sequences)

SEQ ID NO: 1 - protein, 275 aa, Bacillus amyloliquefaciens [sequence omitted]

SEQ ID NO: 2 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 3 - protein, 182 aa, Bacillus cibi [sequence omitted]

SEQ ID NO: 4 - protein, 324 aa, Terribacillus saccharophilus [sequence omitted]